(19) United States
(12) Patent Application Publication
(10) Pub. No.: US 2024/0236890 A1
(43) Pub. Date: Jul. 11, 2024

(54) METHOD AND DEVICE FOR PROVIDING TIME SYNCHRONIZATION IN WIRELESS COMMUNICATION SYSTEM

(71) Applicant: Samsung Electronics Co., Ltd., Suwon-si (KR)

(72) Inventor: Sangjun MOON, Suwon-si (KR)

(21) Appl. No.: 18/544,925

(22) Filed: Dec. 19, 2023

(30) Foreign Application Priority Data
Jan. 6, 2023 (KR) 10-2023-0002377

(51) Int. Cl. H04W 56/00

(52) U.S. Cl. CPC H04W 56/0015

(57) ABSTRACT

The disclosure relates to a fifth generation (5G) or sixth generation (6G) communication system for supporting a higher data transmission rate. A method for providing time synchronization in a wireless communication system is provided. The method includes receiving, by a user equipment (UE) from a base station, a reference identification (ID) based on a time synchronization status information received from a network entity by the base station, and receiving, by the UE from the base station, the time synchronization status information via radio resource control (RRC) signaling.

### CROSS-REFERENCE TO RELATED APPLICATION(S)

This application is based on and claims priority under 35 U.S.C. § 119(a) of a Korean patent application number 10-2023-0002377, filed on Jan. 6, 2023, in the Korean Intellectual Property Office, the disclosure of which is incorporated by reference herein in its entirety.

### BACKGROUND

### 1. Field

The disclosure relates to a method and device for providing time synchronization in a wireless communication system.

### 2. Description of Related Art

Fifth generation (5G) mobile communication technology defines a wide frequency band to enable fast transmission speed and new services and may be implemented in frequencies below 6 gigahertz (GHz) (‘sub 6 GHz’), such as 3.5 GHz, as well as in ultra-high frequency bands (‘above 6 GHz’), such as 28 GHz and 39 GHz called millimeter wave (mmWave). Further, sixth generation (6G) mobile communication technology, which is called a beyond 5G system (5GS), is considered to be implemented in terahertz (THz) bands (e.g., 95 GHz to 3 THz) to achieve a transmission speed 50 times faster than 5G mobile communication technology and ultra-low latency reduced by 1/10.

In the early stage of 5G mobile communication technology, standardization was conducted on beamforming and massive multiple-input multiple-output (MIMO) for mitigating propagation pathloss and increasing propagation distance in ultrahigh frequency bands, support for various numerologies for efficient use of ultrahigh frequency resources (e.g., operation of multiple subcarrier gaps), dynamic operation of slot format, initial access technology for supporting multi-beam transmission and broadband, definition and operation of bandwidth part (BWP), new channel coding, such as low density parity check (LDPC) code for massive data transmission and polar code for high-reliable transmission of control information, L2 pre-processing, and network slicing for providing a dedicated network specified for a specific service, so as to meet performance requirements and support services for enhanced mobile broadband (eMBB), ultra-reliable low-latency communications (URLLC), and massive machine-type communications (mMTC).

Currently, improvement and performance enhancement in the initial 5G mobile communication technology is being discussed considering the services that 5G mobile communication technology has intended to support, and physical layer standardization is underway for technology, such as vehicle-to-everything (V2X) for increasing user convenience and assisting autonomous vehicles in driving decisions based on the position and state information transmitted from the voice over new radio (VoNR), new radio unlicensed (NR-U) aiming at the system operation matching various regulatory requirements, new radio (NR) user equipment (UE) power saving, non-terrestrial network (NTN) which is direct communication between UE and satellite to secure coverage in areas where communications with a terrestrial network is impossible, and positioning technology.

Also being standardized are radio interface architecture/protocols for technology of industrial Internet of things (IIoT) for supporting new services through association and fusion with other industries, integrated access and backhaul (IAB) for providing nodes for extending the network service area by supporting an access link with the radio backhaul link, mobility enhancement including conditional handover and dual active protocol stack (DAPS) handover, 2-step random access channel (RACH) for NR to simplify the random access process, as well as system architecture/service fields for 5G baseline architecture (e.g., service based architecture or service based interface) for combining network functions virtualization (NFV) and software-defined networking (SDN) technology and mobile edge computing (MEC) for receiving services based on the position of the UE.

As 5G mobile communication systems are commercialized, soaring connected devices would be connected to communication networks so that reinforcement of the function and performance of the 5G mobile communication system and integrated operation of connected devices are expected to be needed. To that end, new research is to be conducted on, e.g., extended reality (XR) for efficiently supporting, e.g., augmented reality (AR), virtual reality (VR), and mixed reality (MR), and 5G performance enhancement and complexity reduction using artificial intelligence (AI) and machine learning (ML), support for AI services, support for metaverse services, and drone communications.

Further, development of such 5G mobile communication systems may be a basis for multi-antenna transmission technology, such as new waveform for ensuring coverage in 6G mobile communication terahertz bands, full dimensional MIMO (FD-MIMO), array antenna, and large scale antenna, full duplex technology for enhancing the system network and frequency efficiency of 6G mobile communication technology as well as reconfigurable intelligent surface (RIS), high-dimensional space multiplexing using orbital angular momentum (OAM), metamaterial-based lens and antennas to enhance the coverage of terahertz band signals, AI-based communication technology for realizing system optimization by embedding end-to-end AI supporting function and using satellite and artificial intelligence (AI) from the step of design, and next-generation distributed computing technology for implementing services with complexity beyond the limit of the UE operation capability by way of ultrahigh performance communication and computing resources.

The above information is presented as background information only to assist with an understanding of the disclosure. No determination has been made, and no assertion is made, as to whether any of the above might be applicable as prior art with regard to the disclosure.

### SUMMARY

A need exists for a method for providing a sync status to user equipment (UEs) while simultaneously providing coverage conditions when a Fifth generation (5G) system becomes a synchronization source to provide a time synchronization service to the UEs.

An idle UE moves between base stations without separate signaling in the same registration area (RA), but it is ensured that the synchronization conditions are identical in the RA.

Aspects of the disclosure are to address at least the above-mentioned problems and/or disadvantages and to provide at least the advantages described below. Accordingly, an aspect of the disclosure is to provide a method and device for providing time synchronization between UEs in a wireless communication system.

Another aspect of the disclosure is to provide a method and device for providing a sync status to a UE when providing time synchronization between wireless UEs using synchronization range conditions in a wireless communication system.

Additional aspects will be set forth in part in the description which follows and, in part, will be apparent from the description, or may be learned by practice of the presented embodiments.

In accordance with an aspect of the disclosure, a method for providing time synchronization in a wireless communication system is provided. The method includes receiving, by a user equipment (UE) from a base station, a reference identification (ID) based on a time synchronization status information received from a network entity by the base station, and receiving, by the UE from the base station, the time synchronization status information via radio resource control (RRC) signaling.

In accordance with another aspect of the disclosure, a method for providing time synchronization in a wireless communication system is provided. The method includes receiving, by a base station from a network entity, time synchronization status information, transmitting, by the base station to a user equipment (UE), a reference identification (ID) based on the time synchronization status information, and transmitting, by the base station to the UE, the time synchronization status information via radio resource control (RRC) signaling.

In accordance with another aspect of the disclosure, a user equipment (UE) for providing time synchronization in a wireless communication system is provided. The UE includes a transceiver, and at least one processor coupled to the transceiver and configured to receive, from a base station, a reference identification (ID) based on a time synchronization status information received from a network entity by the base station, and receive, from the base station, the time synchronization status information via radio resource control (RRC) signaling.

In accordance with another aspect of the disclosure, a base station for providing time synchronization in a wireless communication system is provided. The base station includes a transceiver, and at least one processor coupled to the transceiver and configured to receive, from a network entity, time synchronization status information, transmit, by the base station to a user equipment (UE), a reference identification (ID) based on the time synchronization status information, and transmit, to the UE, the time synchronization status information via radio resource control (RRC) signaling.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a method for transferring a sync status to a user equipment (UE) when providing a fifth generation system (5GS) synchronization service through a third generation partnership project (3GPP) communication network according to an embodiment of the disclosure;

FIG. 2 illustrates a handover scenario of an idle UE between registration areas (RAs) or in an RA according to an embodiment of the disclosure;

FIGS. 3A and 3B illustrate scenarios in which a sync status needs to be updated when a sync coverage condition is changed upon handover of an idle UE in an RA according to various embodiments of the disclosure;

FIG. 4 illustrates a process of using a system information block (SIB) to transfer a sync status to an idle UE when providing time synchronization through a 3GPP communication network according to an embodiment of the disclosure;

FIGS. 5A and 5B illustrate scenarios in which an idle UE performs a sync status update when identifying a sync status according to various embodiments of the disclosure;

FIG. 6 illustrates an operation in which a UE performs handover in a same sync range according to an embodiment of the disclosure;

FIG. 7 illustrates an operation in which a UE performs handover to another sync range according to an embodiment of the disclosure;

FIG. 8 illustrates an operation in which a UE performs a sync status update in a same sync range according to an embodiment of the disclosure; and

FIG. 9 is a block diagram illustrating a device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims. The same reference numeral denotes the same element throughout the specification.

It should be appreciated that the blocks in each flowchart and combinations of the flowcharts may be performed by one or more computer programs which include instructions. The one or more programs may be stored in a single memory or divided among multiple memories.

Further, each block may represent a module, segment, or part of a code including one or more executable instructions for executing a specified logical function(s). Further, it should also be noted that in some replacement embodiments of the disclosure, the functions mentioned in the blocks may occur in different orders. For example, two blocks that are consecutively shown may be performed substantially simultaneously or in a reverse order depending on corresponding functions.

As used herein, the term “unit” means a software element or a hardware element, such as a field-programmable gate array (FPGA) or an application specific integrated circuit (ASIC). A unit plays a certain role. However, a ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more central processing units (CPUs) in a device or secure multimedia card. According to embodiments of the disclosure, a “. . . unit” may include one or more processors.

Functions in the claims can be processed by one processor or a combination of processors. The one processor or a combination of processors is circuitry performing processing and includes circuitry like CPU, microprocessor unit (MPU), access point (AP), CP, system on chip (SoC), or integrated circuit (IC).

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, terms for identifying access nodes, terms denoting network entities, terms denoting messages, terms denoting inter-network entity interfaces, and terms denoting various pieces of identification information are provided as an example for ease of description. Thus, the disclosure is not limited to the terms, and the terms may be replaced with other terms denoting objects with equivalent technical meanings.

In the disclosure, the base station (BS) is a network entity allocating resources to the UE and capable of communicating with the UE and may be at least one of an eNode B, a Node B, a gNB, a radio access network (RAN), an access network (AN), a RAN node, an integrated access/backhaul (IAB) node, a radio access unit, a base station controller, a node over network, or a transmission reception point (TRP). The user equipment (UE) may be at least one of a terminal, a mobile station (MS), cellular phone, smartphone, computer, or multimedia system capable of performing communication functions.

For ease of description, the terms and names defined in the latest 3rd generation partnership project 5G and NR standards among the current communication standards are used herein. However, the disclosure is not limited by such terms and names and may be likewise applicable to wireless communication networks conforming to other standards. More particularly, the disclosure may be applied to 3GPP GS/NR (5th generation mobile communication standards).

Accurate time synchronization between UEs is required when using an application, such as a smart grid. A synchronization service may only be provided in a specific area. Outside this area, it is not required to provide a synchronization service, or it may be required to apply a different type of synchronization service.

Further, factory automation requires accurate time synchronization between UEs. Applications that share audio/video also require accurate time synchronization between UEs. Financial applications require time synchronization as well. For example, a stock trading application needs to sell and buy stocks based on accurate time synchronization between trading UEs.

In the disclosure, the network technology may refer to the standards (e.g., TS 23.501, TS 23.502, TS 23.503, etc.) defined by the international telecommunication union (ITU) or 3GPP, and the components included in the network architecture described below may mean physical entities or may mean software that performs an individual function or hardware combined with software.

The 3GPP standard standardized the 5G network system architecture and procedures. A mobile network operator may provide various services in a 5G network. To provide each service, the mobile network operator needs to meet different service requirements (e.g., latency, communication range, data rate, bandwidth, reliability, etc.) for each service. To that end, the 5G system may support network slicing (or may be referred to as the network slice), and traffic for different network slices may be handled by different PDU sessions. The PDU session may mean an association between a data network providing a PDU connection service and a UE. The network slice may be understood as technology for logically configuring a network with a set of network functions (NF) to support various services with different characteristics, such as wideband communication services, massive IoT, V2X, or other mission critical services, and separating different network slices. Therefore, even when a communication failure occurs in one network slice, communication in other network slices is not affected, so that it is possible to provide a stable communication service. To that end, the mobile network operator may constitute the network slice and may allocate network resources suitable for a specific service for each network slice or for each set of network slices. The network resource may mean a network function (NF) or logical resource provided by the NF or radio resource allocation of a base station. For example, the mobile network operator may configure network slice A for providing a mobile wideband service, network slice B for providing a vehicle communication service, and network slice C for providing an IoT service. In other words, the 5G system may efficiently provide a corresponding service to a UE through a specialized network slice suited for the characteristics of each service.

In the drawings, reference numerals shown as N1, N2, N3, . . . , Nxxx indicate known interfaces between the network functions in the 5G system. The 3GPP system defines a conceptual link connecting NFs in the 5G system as a reference point. Reference points included in the 5G system structure are described as an example below.
N1: Reference point between the UE and the access and mobility management function (AMF)
N2: Reference point between the base station (R)AN and the AMF
N3: Reference point between the base station ((R)AN) and the user plane function (UPF)
N4: Reference point between the session management function (SMF) and the UPF
N5: Reference point between the policy control function (PCF) and the application function (AF)
N6: Reference point between the UPF and the data network (DN)
N7: Reference point between SMF and PCF
N8: Reference point between the user data management (UDM) and the AMF
N9: Reference point between two core UPFs
N10: Reference point between UDM and SMF
N11: Reference point between AMF and SMF

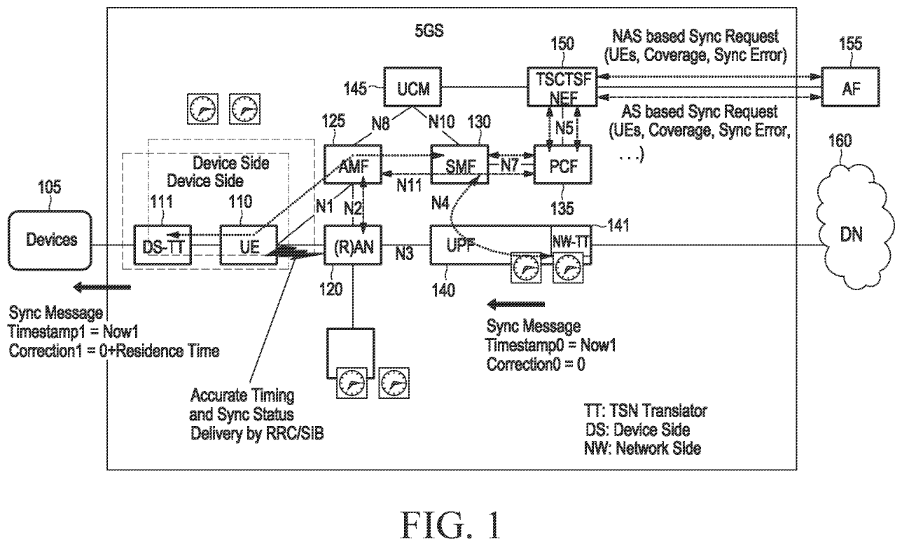

The 5G system may include a 5G core network (5GC), a base station, and a user equipment (UE). The 5GC may include an AMF that manages mobility of the UE, an SMF that manages the session, a UPF that is connected to the data network (DN) and plays a role to transfer data, a network exposure function (NEF) that transfers or receives the event occurring in the 5G system and the capability to be supported to the outside, a PCF that provides the policy control function of the network operator, and a UDM that provides the function of managing data, such as subscriber data and policy control data, and the AF that provides the application service may communicate with the 5GC. The AMF is a network entity for managing access and mobility of the UE. The AMF may perform such network functions as registration of the UE, connection, reachability, mobility management, access identification, authentication, and mobility event generation. The SMF may perform a management function for a protocol data unit (PDU) session of the UE. For example, the SMF may perform such network functions as session management functions of establishing, modifying, or releasing a session and maintaining a tunnel between the UPF and the base station, the functions of allocating and managing an Internet protocol (IP) address of the UE, selection and control of the user plane. The UPF may perform a data processing function of transferring data transmitted by the UE to the DN, which is an external network, or transferring data received from the DN to the UE. Further, the UPF may perform network functions, such as acting as an anchor between radio access technologies (RATs), providing connection with PDU sessions and the AF, packet routing and forwarding, packet inspection, application of user plane policy, creating a traffic usage report, or buffering. The PCF may manage operator policy information for providing the service in the 5G system, and the UDM may perform functions, such as generating authentication information for 3GPP security, managing the list of NFs supporting the UE, and managing subscription information. The unified data repository (UDR) may perform the functions of storing and providing subscription information managed by the UDM, structured data for exposure, and application data related to NEF or service. Meanwhile, in a UE registration procedure, the UE may transmit, to the AMF, identification information about network slices to be requested (requested single-network slice selection assistance information (S-NSSAIs)), and the AMF may provide the UE with information about a network slice available to the UE (allowed NSSAI) based on the requested S-NSSAIs, subscriber information, and the like. In order to transmit and receive data to and from a specific data network (DN) through allowed slices (allowed NSSAIs), the UE may select one of the allowed slices, request the data network name (DNN) for the network slice selected from among the allowed network slices to generate a PDU session, and transmit and receive data through the generated PDU session. In the embodiments of FIGS. 1, 2, 3A, 3B, 4, 5A, 5B, and 6 to 8, basic functions of network entities, such as the NEF, a UDM 145, a UPF 140, a PCF 135, an SMF 130, an AMF 125, a (R)AN 120, and a DN 160 are the same as those described above.

FIG. 1 illustrates a principle for transferring a sync status to a UE when providing a 5GS synchronization service through a 3GPP communication network according to an embodiment of the disclosure.

Referring to FIG. 1, a 5G system may provide a synchronization service to a UE at the request of the application function (AF) 255. The 5G system interworks with an external AF 255 through the time sensitive communications and time synchronization function (TSCTSF)/network exposure function (NEF) 250. In this case, the TSCTSF/NEF 250 may exchange management information with the network side TSN translator (NW-TT) 141 and the devices 105 side TSN translator (DS-TT) 111. The NW-TT 141 may periodically generate a sync message for synchronizing, and transmit time information to the DS-TT 111.

The TSCTSF/NEF 150 may interwork with a session management function (SMF) 130, an access and mobility management function (AMF) 125, a policy control function (PCF) 135, and a unified data management (UDM)/user data repository (UDR) to transfer information about the 5G system to the external AF 155 or to apply a request of the external AF 155 to the 5G system. More particularly, the TSCTSF/NEF 150 may store information necessary for the UDR and transfer the updated information to the UDM/UDR or the policy control function (PCF) 135 through a notification via a notification process. This method may be called a non-access stratum (NAS)-based method.

The request of the AF 155 may be transferred to the radio access network (RAN) 120 of the 5G system, and the RAN 120 may support time synchronization between UEs by adjusting radio resource control (RRC) or system information block (SIB). The RAN 120 may control the synchronization function using the parameter. This method may be called an access stratum (AS)-based method.

The RAN 120 may increase the frequency of transmitting the RRC/SIB for transferring time information, as much as meeting the accuracy. The base station may adjust the accuracy of time synchronization by measuring a precise delay time by adjusting the period of exchanging messages for measuring the delay time between a specific UE and the base station through RRC. Further, the base station may adjust the frequency of including the time information in the SIB broadcast to all UEs and transferring the same, thereby adjusting the time sync accuracy.

Although the request of the AF 155 is performed based on one of NAS or AS, the AF 155 does not know the internal status information about the 5G system, such as supportable sync accuracy, the number of corresponding UEs, and the status (idle/active) of the corresponding UE. Accordingly, although the AF 1500 requests based on the NAS, 5G system synchronization should be processed based on the AS. Further, although the AF 155 requests based on the AS, 5G system synchronization should be processed based on the NAS. Or, although the AF 155 requests based on the NAS or the AS, AS-based 5G system synchronization and NAS-based 5G system synchronization both should be able to be processed.

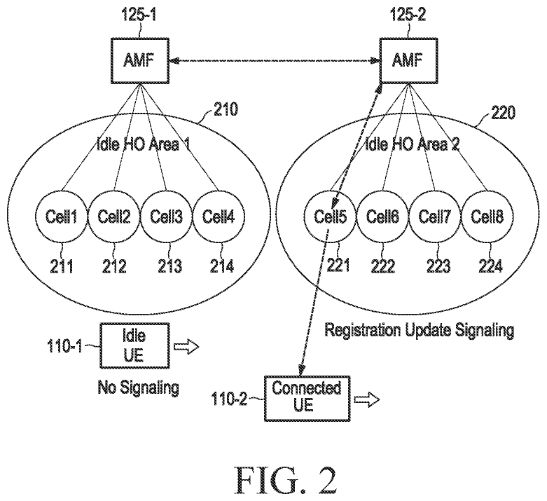

FIG. 2 is a view illustrating a handover scenario of an idle UE between RAs or in an RA according to an embodiment of the disclosure.

Referring to FIG. 2, cells 1, 2, 3, and 4 211 to 214 are included in one registration area (RA) 210, and cells 5, 6, 7, and 8 221 to 224 are included in another RA 220. In this case, when the UE 110-1 in the RRC_Idle state moves from cell 2 212 to cell 3 213, this movement is a movement within the same RA 210, and thus no separate signaling occurs. As another example, when the UE 110-1 in the RRC_Idle state moves from cell 4 214 to cell 5 221, this movement is a movement between different RAs (i.e., from RA1 210 to RA2 220), and thus the UE 110-2 changes the state to RRC_Connected and performs registration update signaling. In this case, the AMF may be changed (i.e., AMF 125-1 or AMF 125-2) or the same AMF may be used. The UE 110-2 changed to RRC_Connected may be changed back to the RRC_Idle state when no separate traffic occurs for a predetermined time.

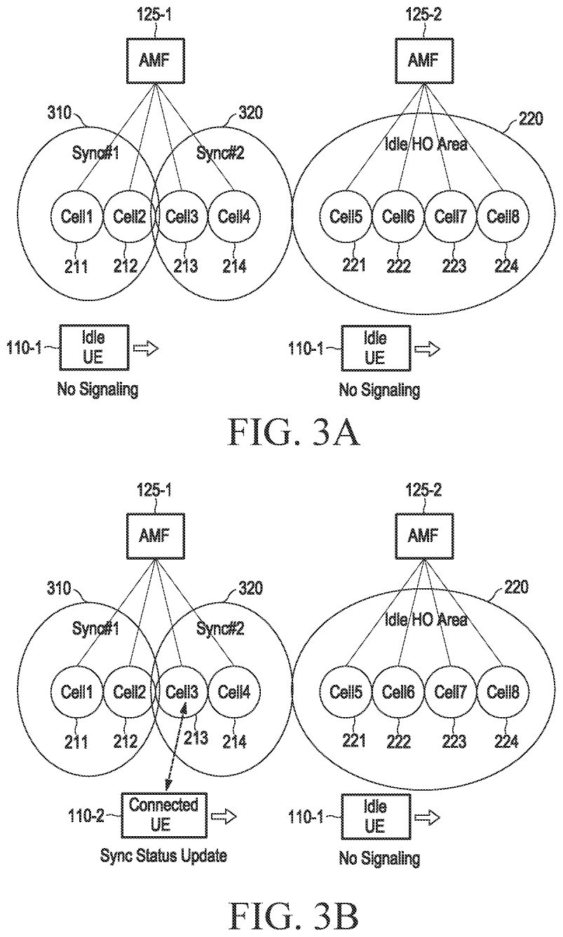

FIGS. 3A and 3B illustrate scenarios in which a sync status needs to be updated when a sync coverage condition is changed upon handover of an idle UE in an RA according to various embodiments of the disclosure.

Referring to FIGS. 3A and 3B, a coverage condition for a NAS/AS-based sync request of AF or a sync service subscription of UDM may be different from that of RA. For example, when the coverage condition for the sync request is Cell list A, the handover area RA of the UE in the idle state may be Cell list B. Further, e.g., when a sync status change input from a RAN/core network (CN)/operation, administration and management (OAM) is provided to the TSCTSF, the changed range condition may be Cell list C, and the handover area RA of the UE in the idle state may be Cell list B. The UE may identify the sync error budget, the sync source type, and the sync source accuracy information included in the sync status, and may continue to identify whether a condition required by the application of the UE is met. If the sync service of the 5G system does not meet the requirements, the application needs may be supported using other sync services, such as other GPS-based sync services or wired sync services. If the sync service of the 5G system does not meet the requirements, and there is no other service to replace it, it may be indicated to the application to stop the running application, or the running application may be rendered to be continuously used despite a difference in performance.

Referring to FIG. 3A, the UE 110-1 in the RRC_Idle state moves from cell 1 211 to cell 2 212. In this case, since cell 1 211 and cell 2 212 provide Sync #1 310 in the same sync status, there is no need for separate sync status update signaling to occur, and the UE 110-1 continues to maintain the RRC_Idle state. Further, since cell 1 211 and cell 2 212 belong to the same RA 210, there is no need to perform separate signaling for handover, and thus the UE 110-1 continues to maintain the RRC_Idle state.

Referring to FIG. 3B, the UE 110-1 in the RRC_Idle state moves from cell 2 212 to cell 3 213. In this case, since cell 2 212 and cell 3 213 belong to the same RA 210, there is no need to perform separate signaling for handover, and the UE 110-1 may continue to maintain the RRC_Idle state. However, cell 2 212 and cell 3 213 have Sync #1 310 and Sync #2 320 in different sync statuses, respectively. Accordingly, Sync #2 320 in the sync status of cell 3 213 should be transferred to the UE 110-1. To that end, the UE 110-2 is changed to the RRC_Connected state to perform sync status update through RRC.

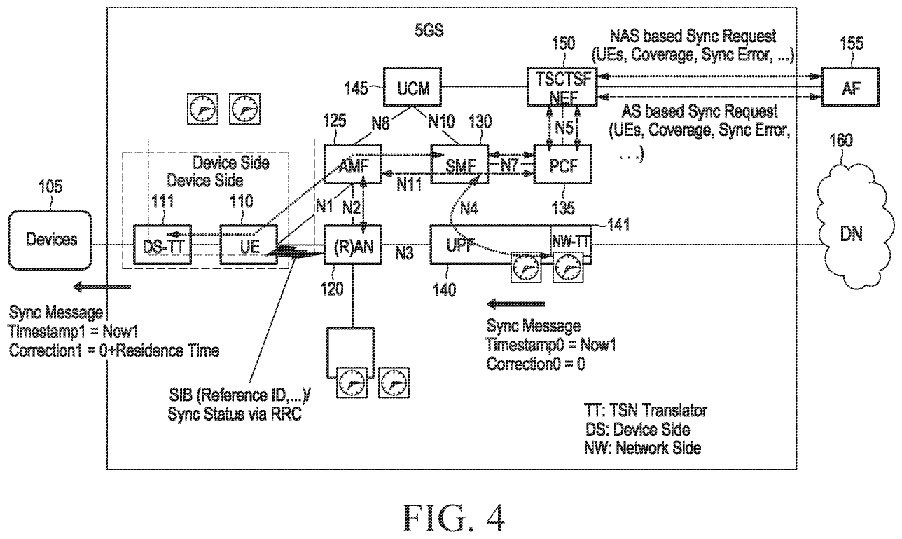

FIG. 4 illustrates a process of using an SIB to transfer a sync status to an idle UE when providing time synchronization through a 3GPP communication network, according to an embodiment of the disclosure.

Referring to FIG. 4, a 5G system includes a reference identifier (ID) indicating a sync status update in an SIB for each cell, broadcasts the reference ID, and transfers the reference ID to a UE. When the UE 110 in the RRC_Idle state moves between cells, the UE 110 may reference only the reference ID in the sync status broadcast to the SIB. If this value is the same as the value previously known by the UE, the UE 110 does not need to perform a separate sync status update. Conversely, when this value is different from a value previously known by the UE, the UE 110 performs sync status update signaling to identify a new sync status.

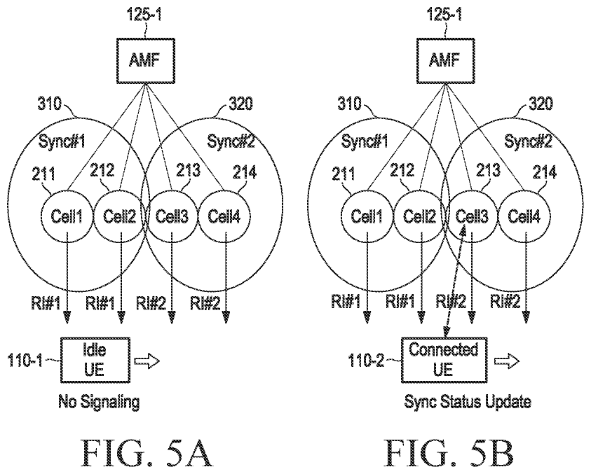

FIGS. 5A and 5B illustrate scenarios in which an idle UE performs a sync status update when identifying a sync status according to various embodiments of the disclosure.

Referring to FIG. 5A, when the UE 110-1 in the RRC_Idle state moves from cell 1 211 to cell 2 212, because cell 1 211 and cell 2 212 belong to the same RA 210, the UE 110-1 does not need to perform separate signaling for handover. Further, when cell 1 211 and cell 2 212 have Sync #1 310 in the same sync status, cell 1 211 and cell 2 212 broadcast the same reference ID through the SIB. Therefore, since the UE 110-1 receives the same reference ID as the reference ID received from cell 1 211 from cell 2 212, the UE 110-1 does not perform separate signaling for sync status update.

Referring to FIG. 5B, when the UE 110-1 in the RRC_Idle state moves from cell 2 212 to cell 3 213, because cell 2 212 and cell 3 213 belong to the same RA 210, the UE 110-1 does not need to perform separate signaling for handover. Further, when cell 2 212 and cell 3 213 have Sync #1 310 and Sync #2 320 in different sync statuses, respectively, cell 2 212 and cell 3 213 broadcast different reference IDs through the SIB. Therefore, since the UE 110-1 receives the reference ID different from the reference ID received from cell 2 212 from cell 3 213, the UE 110-1 performs separate signaling for sync status update.

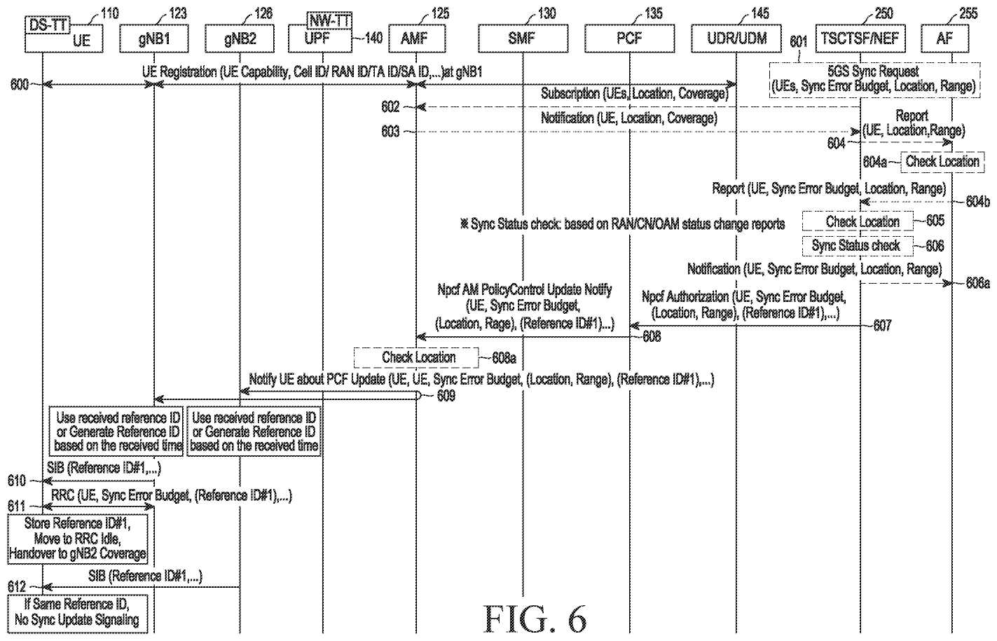

FIG. 6 illustrates an operation in which a UE performs handover in a same sync range according to an embodiment of the disclosure.

Referring to FIG. 6, in operation 600, the UE 110 sends a UE registration. The UE registration includes UE Capability, which indicates that a sync service of a 5G system may be supported. Further, the UE registration may include a cell ID or a RAN ID, or a TA ID and an SA ID where the UE 110 is located. The RAN ID, TA ID, or SA ID may be derived from the cell ID. The UE registration is transferred to the UDR/UDM 145 through the AMF 125. The UDM 145 may identify whether the UE 110 has a service subscription to receive a 5G system sync service. The service subscription information may include information about the UE 110, requirements, such as sync error bounds, and coverage conditions.

In operation 601, the AF 255 may send a 5GS sync request for the target UEs to the TSCTSF/NEF 250. This request includes the required sync accuracy as the sync error budget. Further, the coverage to which the sync service is to be applied may be referred to as a location or a range. The target UEs may be represented with a UE ID list, a group ID, or a data network name (DNN)/single network slice selection assistance information (S-NSSAI).

In operation 602, the TSCTSF/NEF 250 may request the AMF 125 to notify the target UEs of the location and range information. In this case, location/range may be converted into a RAN ID, a TA ID, a SA ID, a cell ID, or the like, which may be known in 3GPP, and may be used.

In operation 603, the AMF 125 may notify the TSCTSF/AMF 250 of the location and range information about the corresponding UE 110.

In operation 604, the TSCTSF/NEF 250 may report the location and range of the corresponding UE 110 to the AF 255.

In operation 604a, the AF 255 may determine whether the location information about the UE 110 meets a requirement.

In operation 604b, the AF 255 may send a 5GS sync request for the UE 110 to the TSCTSF/NEF 250.

In operation 605, the TSCTSF/NEF 250 may determine whether the location information about the UE 110 meets a requirement.

In operation 606, the TSCTSF/NEF 250 may receive a sync status change from the RAN/CN/OAM and determine whether to update the sync status. An input of changing the sync status in the RAN may occur due to congestion in a specific area, or an input of changing the sync status from the CN to the TSCTSF/NEF 250 may occur to update the sync status of the UE 110 through a report from the UPF 140 after the interaction between the UE 110 and the UPF 140. Further, when the OAM detects a status abnormality, such as in RAN or CN, an input of changing the sync status from the OAM to the TSCTSF/NEF 250 may be generated so that the OAM requests a sync status change. The TSCTSF/NEF 250 may determine whether to update the sync status by comprehending these inputs.

In operation 606a, the TSCTSF/NEF 250 may notify the AF 255 of the current sync status by reflecting the changed sync status of the UE 110.

In operation 607, the TSCTSF/NEF 250 may transfer the 5GS sync request for the UE 110 to the PCF 135. In this case, the request transferred from the TSCTSF/NEF 250 to the PCF 135 may include the required sync accuracy as the sync error budget. It is also possible to specify the range where the sync service should be applied based on location or range. In this case, a reference ID (e.g., reference ID #1) may be included as information indicating the time or event of transferring the sync status.

In operation 608, the PCF 135 may transfer a 5GS sync request for the UE 110 meeting the location or range condition to the AMF 125. In this case, the request transferred from the PCF 135 to the AMF 125 may include the required sync accuracy as the sync error budget. It is also possible to specify the range where the sync service should be applied based on location or range. In this case, a reference ID (e.g., reference ID #1) may be included as information indicating the time or event of transferring the sync status. This reference ID may be received from the TSCTSF 250 or may be generated by the PCF 135.

In operation 608a, the AMF 125 may determine whether the location information about the UE 110 meets a requirement.

In operation 609, the AMF 125 requests at least one gNB to apply sync accuracy to the UE 110 meeting the condition. In this case, the request may include a sync error budget. In this case, the request may be simultaneously sent to all gNBs corresponding to the range condition, i.e., to gNB1 123 and gNB2 126. In this case, a reference ID (e.g., reference ID #1) may be included as information indicating the time or event of transferring the sync status. This reference ID may be received from the TSCTSF 250 or may be generated by the PCF 135.

In operation 609, each of the gNBs 120 and 125 may increase/decrease the system information block (SIB) broadcast period based on the sync error budget information transferred from the 5GC or may increase/decrease the delay time measurement period between the gNB and the UE to meet the time sync accuracy requirement of the UE to measure the radio resource control (RRC) timing advance (TA) value with each UE.

Further, each gNB 120 or 125 may store the reference ID (e.g., reference ID #1) indicating the time or event of receiving the sync status information received from the AMF 125 or may directly generate and store the reference ID based on the time when the sync status information is received. Further, each of the gNBs 120 and 125 may include the reference ID in the SIB and broadcast it periodically. Each of the gNBs 120 and 125 may allow gNBs having the same sync status to have the same group ID, generate a reference ID including the group ID and include the reference ID in the SIB, and periodically broadcast the reference ID.

In operation 610, the UE 110 receives the SIB from gNB1 123 where it is camping. In this case, the UE 110 identifies that the reference ID #1 included in the SIB is a new value. The UE 110 may store a plurality of latest reference IDs and then use them for comparison.

In operation 611, the UE 110 performs RRC signaling with gNB1 123 to receive a detailed sync status. The UE 110 stores reference ID #1, which is the reference ID of the most recently performed sync status update. Thereafter, when there is no traffic for a predetermined period of time, the UE 110 switches to the RRC_Idle state and moves to gNB2 126.

In operation 612, the UE 110 receives the SIB from gNB2 126 where it is camping. In this case, since the reference ID #1 included in the SIB is the same value as the previously stored value, the UE 110 does not perform a separate sync status update.

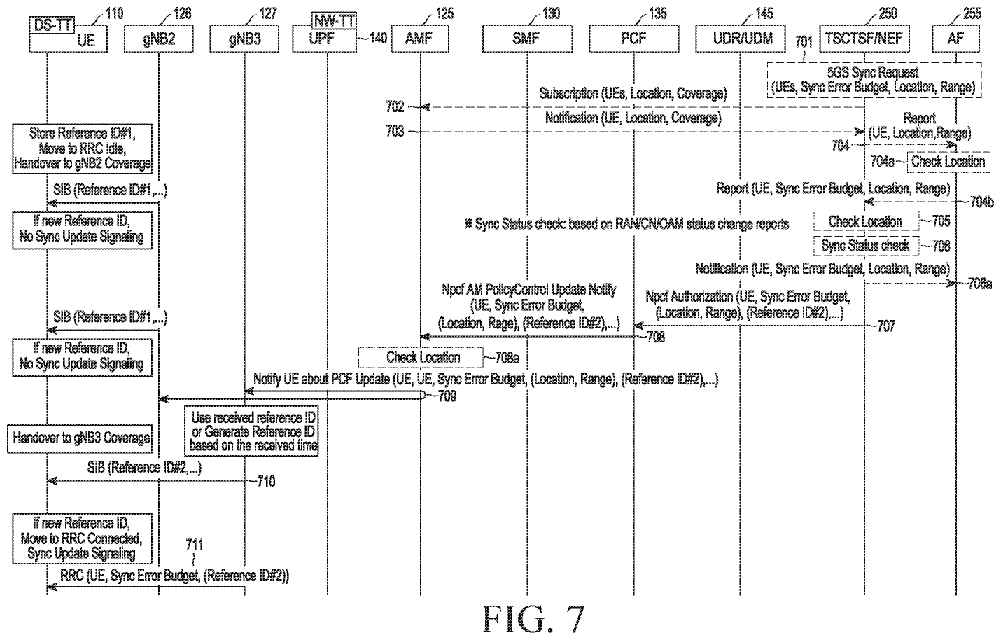

FIG. 7 illustrates an operation when a UE hands over to another sync range, according to an embodiment of the disclosure.

Referring to FIG. 7, in operation 701, the AF 255 may send a 5GS sync request for target UEs to the TSCTSF/NEF 250. This request may include the required sync accuracy as the sync error budget. It is also possible to specify the range where the sync service should be applied based on location or range. The target UEs may be represented with a UE ID list, a group ID, or a DNN/S-NSSAI.

In operation 702, the TSCTSF/NEF 250 may request the AMF 125 to notify the target UEs of the location and range information. In this case, location/range may be converted into a RAN ID, a TA ID, a SA ID, a cell ID, or the like, which may be known in 3GPP, and may be used.

In operation 703, the AMF 125 may notify the TSCTSF/AMF 250 of the location and range information about the corresponding UE 110.

In operation 704, the TSCTSF/NEF 250 may report the location and range of the corresponding UE 110 to the AF 255.

In operation 704a, the AF 255 may determine whether the location information about the UE 110 meets a requirement.

In operation 704b, the AF 255 may send a 5GS sync request for the UE 110 to the TSCTSF/NEF 250.

In operation 705, the TSCTSF/NEF 250 may determine whether the location information about the UE 110 meets a requirement.

In operation 706, the TSCTSF/NEF 250 may receive a sync status change from the RAN/CN/OAM and determine whether to update the sync status.

In operation 706a, the TSCTSF/NEF 250 may notify the AF 255 of the current sync status by reflecting the changed sync status of the UE 110. An input of changing the sync status in the RAN may occur due to congestion in a specific area, or an input of changing the sync status from the CN to the TSCTSF/NEF 250 may occur to update the sync status of the UE 110 through a report from the UPF 140 after the interaction between the UE 110 and the UPF 140. Further, when the OAM detects a status abnormality, such as in RAN or CN, an input of changing the sync status from the OAM to the TSCTSF/NEF 250 may be generated so that the OAM requests a sync status change. The TSCTSF/NEF 250 may determine whether to update the sync status by comprehending these inputs.

In operation 707, the TSCTSF/NEF 250 may transfer the 5GS sync request for the UE 110 to the PCF 135. In this case, the request transferred from the TSCTSF/NEF 250 to the PCF 135 may include the required sync accuracy as the sync error budget. It is also possible to specify the range where the sync service should be applied based on location or range. In this case, a reference ID (e.g., reference ID #2) may be included as information indicating the time or event of transferring the sync status.

In operation 708, the PCF 135 may transfer a 5GS sync request to the PCF for the UE meeting the location or range condition to the AMF 125. In this case, the request transferred from the PCF 135 to the AMF 125 may include the required sync accuracy as the sync error budget. It is also possible to specify the range where the sync service should be applied based on location or range. In this case, a reference ID (e.g., reference ID #2) may be included as information indicating the time or event of transferring the sync status. This reference ID may be received from the TSCTSF 250 or may be generated by the PCF 135.

In operation 708a, the AMF 125 may determine whether the location information about the UE 110 meets a requirement.

In operation 709, the AMF 125 requests at least one gNB to apply sync accuracy to the UE 110 meeting the condition. In this case, the request may include a sync error budget. In this case, the request may be sent to all gNBs corresponding to the range condition, i.e., to gNB2 126 and gNB3 127. In this case, a reference ID (e.g., reference ID #2) may be included as information indicating the time or event of transferring the sync status. This reference ID may be received from the TSCTSF 250 or may be generated by the PCF 135.

In operation 709, each of the gNBs 125 and 127 may increase/decrease the system information block (SIB) broadcast period based on the sync error budget information transferred from the 5GC or may increase/decrease the delay time measurement period between the gNB and the UE to meet the time sync accuracy requirement of the UE to measure the radio resource control (RRC) timing advance (TA) value with each UE.

Further, each gNB 125 or 127 may store the reference ID (e.g., reference ID #2) indicating the time or event of receiving the sync status information received from the AMF 125 or may directly generate and store the reference ID based on the time when the sync status information is received. Further, each of the gNBs 125 and 127 may include the reference ID in the SIB and broadcast it periodically. Each of the gNBs 125 and 127 may allow gNBs having the same sync status to have the same group ID, generate a reference ID including the group ID and include the reference ID in the SIB, and periodically broadcast the reference ID.

In operation 710, the UE 110 receives the SIB from gNB3 127 where it is camping. In this case, the UE 110 identifies that the reference ID #2 included in the SIB is a new value, and prepares to perform sync status update signaling by switching to the RRC_connected state. Prior to this, whenever the UE 110 receives the SIB including the reference ID #1 from gNB2 126, the UE 110 determines that the reference ID included in the SIB is the same as the previously stored reference ID, and stays in the RRC_Idle state without performing a separate sync status update and, in the state, moves to the area of gNB3 127. The UE 110 may store a plurality of latest reference IDs and then use them for comparison.

In operation 711, the UE 110 performs RRC signaling with gNB3 127 to receive a detailed sync status. The UE 110 stores reference ID #2, which is the reference ID of the most recently performed sync status update. Thereafter, when there is no traffic for a predetermined period of time, the UE 110 switches to the RRC_Idle state and moves to gNB2 126.

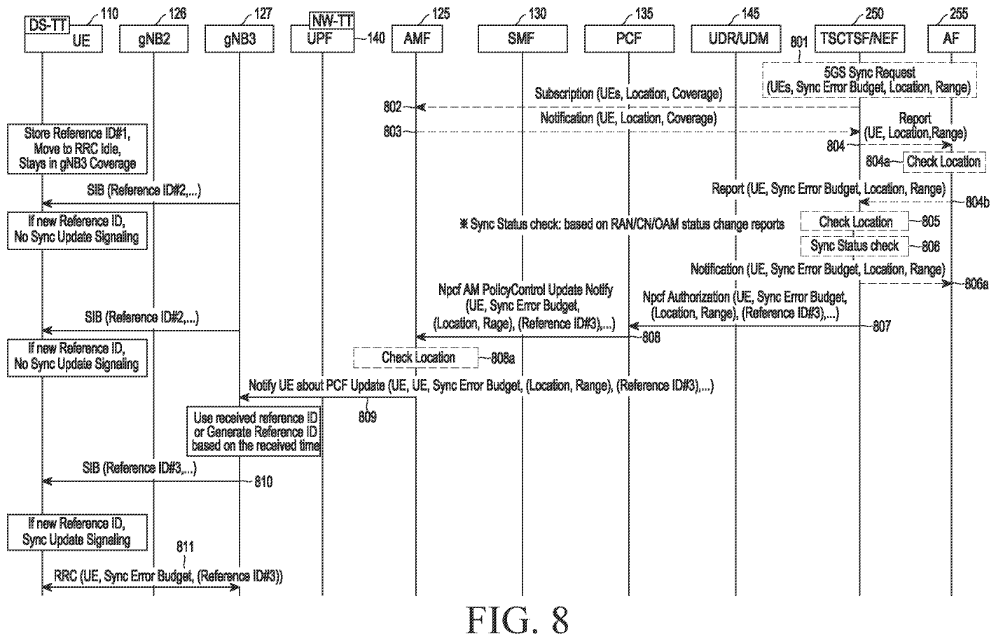

FIG. 8 illustrates an operation in which a UE performs a sync status update in the same sync range according to an embodiment of the disclosure.

Referring to FIG. 8, in operation 801, the AF 255 may send a 5GS sync request for target UEs to the TSCTSF/NEF 250. This request may include the required sync accuracy as the sync error budget. It is also possible to specify the range where the sync service should be applied based on location or range. The target UEs may be represented with a UE ID list, a group ID, or a DNN/S-NSSAI.

In operation 802, the TSCTSF/NEF 250 may request the AMF 125 to notify the target UEs of the location and range information. In this case, location/range may be converted into a RAN ID, a TA ID, a SA ID, a cell ID, or the like, which may be known in 3GPP, and may be used.

In operation 803, the AMF 125 may notify the TSCTSF/AMF 250 of the location and range information about the corresponding UE 110.

In operation 804, the TSCTSF/NEF 250 may report the location and range of the corresponding UE 110 to the AF 255.

In operation 804a, the AF 255 may determine whether the location information about the UE 110 meets a requirement.

In operation 804b, the AF 255 may send a 5GS sync request for the UE 110 to the TSCTSF/NEF 250.

In operation 805, the TSCTSF/NEF 250 may determine whether the location information about the UE 110 meets a requirement.

In operation 806, the TSCTSF/NEF 250 may receive a sync status change from the RAN/CN/OAM and determine whether to update the sync status. An input of changing the sync status in the RAN may occur due to congestion in a specific area, or an input of changing the sync status from the CN to the TSCTSF/NEF 250 may occur to update the sync status of the UE 110 through a report from the UPF 140 after the interaction between the UE 110 and the UPF 140. Further, when the OAM detects a status abnormality, such as in RAN or CN, an input of changing the sync status from the OAM to the TSCTSF/NEF 250 may be generated so that the OAM requests a sync status change. The TSCTSF/NEF 250 may determine whether to update the sync status by comprehending these inputs.

In operation 806a, the TSCTSF/NEF 250 may notify the AF 255 of the current sync status by reflecting the changed sync status of the UE 110.

In operation 807, the TSCTSF/NEF 250 may transfer the 5GS sync request for the UE 110 to the PCF 135. In this case, the request transferred from the TSCTSF/NEF 250 to the PCF 135 may include the required sync accuracy as the sync error budget. It is also possible to specify the range where the sync service should be applied based on location or range. In this case, a reference ID (e.g., reference ID #3) may be included as information indicating the time or event of transferring the sync status.

In operation 808, the PCF 135 may transfer a 5GS sync request to the PCF for the UE meeting the location or range condition to the AMF 125. In this case, the request transferred from the PCF 135 to the AMF 125 may include the required sync accuracy as the sync error budget. It is also possible to specify the range where the sync service should be applied based on location or range. In this case, a reference ID (e.g., reference ID #3) may be included as information indicating the time or event of transferring the sync status. This reference ID may be received from the TSCTSF 250 or may be generated by the PCF 135.

In operation 808a, the AMF 125 may determine whether the location information about the UE 110 meets a requirement.

In operation 809, the AMF 125 requests at least one gNB to apply sync accuracy to the UE 110 meeting the condition. In this case, the request may include a sync error budget. In this case, the request may be sent to all gNBs corresponding to the range condition, i.e., to gNB3 127. In this case, a reference ID (e.g., reference ID #3) may be included as information indicating the time or event of transferring the sync status. This reference ID may be received from the TSCTSF 250 or may be generated by the PCF 135.

In operation 809, each gNB 127 may increase/decrease the system information block (SIB) broadcast period based on the sync error budget information transferred from the 5GC or may increase/decrease the delay time measurement period between the gNB and the UE to meet the time sync accuracy requirement of the UE to measure the radio resource control (RRC) timing advance (TA) value with each UE.

Further, each gNB 127 may store the reference ID (e.g., reference ID #3) indicating the time or event of receiving the sync status information received from the AMF 125 or may directly generate and store the reference ID based on the time when the sync status information is received. Further, each gNB 127 may include the reference ID in the SIB and broadcast it periodically. Each gNB 127 may allow gNBs having the same sync status to have the same group ID, generate a reference ID including the group ID and include the reference ID in the SIB, and periodically broadcast the reference ID.

In operation 810, the UE 110 receives the SIB from gNB3 127 where it is camping. In this case, the UE 110 identifies that the reference ID #3 included in the SIB is a new value, and prepares to perform sync status update signaling by switching to the RRC_connected state. Prior to this, whenever the UE 110 receives the SIB including the reference ID #2 from gNB3 127, the UE 110 determines that the reference ID included in the SIB is the same as the previously stored reference ID, and stays in the RRC_Idle state without performing a separate sync status update and, in the state, remains in the area of gNB3 127. The UE 110 may store a plurality of latest reference IDs and then use them for comparison.

In operation 811, the UE 110 performs RRC signaling with gNB3 127 to receive a detailed sync status. The UE 110 stores reference ID #3, which is the reference ID of the most recently performed sync status update. Thereafter, when there is no traffic for a predetermined period of time, the UE 110 switches to the RRC_Idle state.

According to the above-described embodiments of the disclosure, when the 5G system becomes a synchronization source and provides a sync status to the UE to provide a sync service to the UE, the 5G system may perform separate signaling when the sync status is changed despite an idle UE moving between base stations in the same RA, so that the UE may receive a detailed sync status.

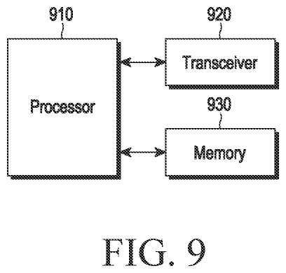

FIG. 9 is a view illustrating a configuration of a network entity in a wireless communication system according to an embodiment of the disclosure.

Referring to FIG. 9, the network entity may be one of such network entities as the AF, TSCTSF, NEF, UDM, PCF, SMF, AMF, UPF, (R)AN, UE, and DN described in connection with the embodiments of FIGS. 1, 2, 3A, 3B, 4, 5A, 5B, and 6 to 8.

The network entity of FIG. 9 may include a processor 910, a transceiver 920, and memory 930. The processor 910, transceiver 920, and memory 930 of the network entity may be operated according to the communication methods of the network entity described above in connection with the embodiments of FIGS. 1, 2, 3A, 3B, 4, 5A, 5B, and 6 to 8. However, the components of the network entity are not limited thereto. For example, the network entity may include more or fewer components than the above-described components. The processor 910, the transceiver 920, and the memory 930 may be implemented in the form of a single chip.

The transceiver 920 collectively refers to the receiver of the network entity and the transmitter of the network entity and may transmit and receive signals to/from a UE or another network entity. The transmitted/received signals may include at least one of control information and data. To that end, the transceiver 920 may include a wired/wireless transceiver and may include various components for transmitting/receiving signals. The transceiver 920 may receive signals through a predetermined communication interface, output the signals to the processor 910, and transmit the signals output from the processor 910. Further, the transceiver 920 may receive the communication signal and output it to the processor 910 and transmit the signal output from the processor 910 to the UE or another network entity through the network. The memory 930 may store programs and data necessary for the operation of the network entity according to at least one of the embodiments of FIGS. 1, 2, 3A, 3B, 4, 5A, 5B, and 6 to 8. Further, the memory 930 may store control information or data that is included in the signal obtained by the network entity. The memory 925 may include a storage medium, such as read only memory (ROM), random access memory (RAM), hard disk, compact disc read only memory (CD-ROM), and digital versatile disc (DVD), or a combination of storage media. Further, the processor 910 may control a series of processes so that the network entity may operate according to at least one of the embodiments of FIGS. 1, 2, 3A, 3B, 4, 5A, 5B, and 6 to 8. The processor 910 may include at least one processor.

The methods according to the embodiments described in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments of the disclosure, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for providing time synchronization in a wireless communication system, the method comprising:
receiving, by a user equipment (UE) from a base station, a reference identification (ID) based on a time synchronization status information received from a network entity by the base station; and
receiving, by the UE from the base station, the time synchronization status information via radio resource control (RRC) signaling.

2. The method of claim 1, wherein the time synchronization status information comprises a synchronization error budget.

3. The method of claim 1, wherein the reference ID comprises information about an event.

4. The method of claim 1, wherein the reference ID is broadcast via a system information block (SIB).

5. The method of claim 1, further comprising:
comparing, by the UE, the received reference ID with a stored reference ID.

6. The method of claim 1, further comprising:
connecting, by the UE, to a network in case that the UE determines that the received reference ID is changed.

7. A method for providing time synchronization in a wireless communication system, the method comprising:
receiving, by a base station from a network entity, time synchronization status information;
transmitting, by the base station to a user equipment (UE), a reference identification (ID) based on the time synchronization status information; and
transmitting, by the base station to the UE, the time synchronization status information via radio resource control (RRC) signaling.

8. The method of claim 7, wherein the time synchronization status information comprises a synchronization error budget.

9. The method of claim 7, wherein the reference ID comprises information about an event.

10. The method of claim 7, wherein the reference ID is broadcast via a system information block (SIB).

11. A user equipment (UE) for providing time synchronization in a wireless communication system, the UE comprising:
a transceiver; and
at least one processor coupled to the transceiver and configured to:
receive, from a base station, a reference identification (ID) based on a time synchronization status information received from a network entity by the base station, and
receive, from the base station, the time synchronization status information via radio resource control (RRC) signaling.

12. The UE of claim 11, wherein the time synchronization status information comprises a synchronization error budget.

13. The UE of claim 11, wherein the reference ID comprises information about an event.

14. The UE of claim 11, wherein the reference ID is broadcast via a system information block (SIB).

15. The UE of claim 11, wherein the processor is further configured to compare the received reference ID with a stored reference ID.

16. The UE of claim 11, wherein the processor is further configured to connect to a network in case that the UE determines that the received reference ID is changed.

17. A base station for providing time synchronization in a wireless communication system, the base station comprising:
a transceiver; and
at least one processor coupled to the transceiver and configured to:
receive, from a network entity, time synchronization status information;
transmit, by the base station to a user equipment (UE), a reference identification (ID) based on the time synchronization status information, and
transmit, to the UE, the time synchronization status information via radio resource control (RRC) signaling.

18. The base station of claim 17, wherein the time synchronization status information comprises a synchronization error budget.

19. The base station of claim 17, wherein the reference ID comprises information about an event.

20. The base station of claim 17, wherein the reference ID is broadcast via a system information block (SIB).
